(19) United States
(12) Patent Application Publication
(10) Pub. No.: US 2005/0228999 A1
(43) Pub. Date: Oct. 13, 2005

(54) Audit records for digitally signed documents

(75) Inventors: Robert Jerdonek, Sunnyvale, CA (US); Thomas J. Wu, Mountain View, CA (US); Do-Pil Park, Redwood City, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Arcot Systems, Inc., Santa Clara, CA (US)

(21) Appl. No.: 11/090,329

(22) Filed: Mar. 24, 2005

Related U.S. Application Data
(60) Provisional application No. 60/561,089, filed on Apr. 9, 2004.

(51) Int. Cl. H04L 9/00

(52) U.S. Cl. 713/176

(57) ABSTRACT

A computer-readable medium having stored thereon computer-executable instructions for implementing a method of verifying a digitally-signed document includes stored instruction for verifying a digital signature related to the document, stored instruction for validating at least one certificate associated with the signature, and stored instruction for storing audit information into a data structure movable as a unit. The audit information relates to verifying the digital signature and validating the at least one certificate, thereby retaining evidence that the document was verified. The instructions further include stored instruction for thereafter displaying the audit information.

### CROSS-REFERENCES TO RELATED APPLICATIONS

This application is a non-provisional of, and claims the benefit of, co-pending, commonly-assigned U.S. Provisional Patent Application No. 60/561,089, entitled “AUDIT RECORDS FOR DIGITALLY SIGNED DOCUMENTS” (attorney docket no. 020967-003100), filed on Apr. 9, 2004, the entire disclosure of which is herein incorporated by reference for all purposes.

### BACKGROUND OF THE INVENTION

The present invention relates generally to digitally-signed documents. More specifically, the present invention relates to systems and methods for creating, storing, archiving, and viewing audit information that pertains to the verification and validation of a digitally-signed document.

The process of securing network communication using public key encryption is well known. Public key encryption helps to ensure that data transmitted using networks remains in tact (i.e., unmodified in transit) and private between the sender and receiver (i.e., reduces eavesdropping). Further, public key encryption also allows a recipient to confirm a sender's identity. These functions are enabled in part through the use of a private key that is retained in secret by a first entity and a public key that the first entity freely distributes to others that wish to securely correspond with it. Public and private keys alone, however, do not fully solve the problem of identity verification as fraudulent public keys can be presented to a sender allowing an attacker to intercept a message. Successful identify verification requires that public keys are distributed by a trusted entity or through a chain of such entities. Certificate authorities (CAs) have been established as clearing houses for the trusted distribution of public keys.

When a recipient receives a document that was encrypted using a public key, the recipient views the content of the document by decrypting it with the corresponding private key. Conversely, a sender might encrypt using the private key, allowing anyone with the public key to decrypt using the freely-available public key. While this does not keep the message secret, if the message decodes correctly, it is probative of the sender's possession of the private key. The possession of the private key can be used as a form of attribution of the message to the sender, in effect “signing” the message.

When a recipient receives a document that was signed using a digital signature, the recipient verifies the digital signature by decrypting it with the public key and comparing the result to a one-way hash of the document. If the results are identical, the recipient is confident that the document was not modified in transit and that the private key used to create the digital signature corresponds to the public key of the sender. Further, the recipient confirms the identity of the sender by validating the certificate or chain of certificates that distributed the public key to the recipient from a CA. Only then is the recipient confident that the sender is the entity that the recipient believes him to be. A similar process is used to reverse the process.

For any number of reasons, the keys and certificates used to verify a signature and validate a sender's identity on a given day may not provide the same assurances in the future. For example, a valid private key at one time might be invalid at another time after a private key is changed. Thus, it may become impossible to recreate the process in the future and a user may forget that a particular document among many was verified and validated. For this reason, it may be important to retain audit records that document the verification and validation process.

Many computer systems that employ cryptographic operations also audit signature verifications and certificate validations. For example, many vendors offer systems implementing the Identrus™ Public Key Infrastructure System. These products record events such as signature verification and certificate validation using, for example, Online Certificate Status Protocol (OCSP) and/or Simple Certificate Validation Protocol (SCVP).

### BRIEF SUMMARY OF THE INVENTION

Embodiments of the invention thus provide a computer-readable medium having stored thereon computer-executable instructions for implementing a method of verifying a digitally-signed document. The instructions include stored instruction for verifying a digital signature related to the document, stored instruction for validating at least one certificate associated with the signature, and stored instruction for storing audit information into a data structure movable as a unit. The audit information relates to verifying the digital signature and validating the at least one certificate, thereby retaining evidence that the document was verified. The instructions further include stored instruction for thereafter displaying the audit information.

In some embodiments, the stored instruction for storing audit information includes stored instruction for storing the audit information on a client computing device. The stored instruction for storing audit information may include stored instruction for storing the audit information on a server computing device. The instructions may include stored instruction for archiving the audit information to an archive server. The stored instruction for storing audit information may include stored instructions for storing the audit information in XML format. The stored instruction for storing audit information may include stored instruction for creating a combined verification report. The combined verification report may include a trusted timestamp that designates a date and time when verifying was performed, digital notarizations associated with at least one signature of the document, an encoded representation of a verified signature, a hash of the document, a transaction ID, a name of the document, document metadata, and/or the like. The encoded representation of a verified signature may include an encoded representation of a verified signature using Base-64 encoding. The hash of the document may include a hash of the document using Base-64 encoding. The stored instruction for storing audit information may include stored instruction for embedding the audit information in the document. The stored instruction for storing audit information may include stored instruction for storing the information in a common directory with the document. The stored instruction for storing audit information may include stored instruction for linking the information to the document using a unique identifier. The document may be in a variety of formats including Adobe Acrobat®, HTML file, XML file, ASCII text file, scanned digital image, or Microsoft® Word document. The digital signature may be in PKCS#7 format. The instructions may include stored instruction for digitally notarizing the audit information. The computer-executable instructions may include a standalone application, a software module, a plug-in, application feature, and/or the like.

In other embodiments, a method of verifying a digitally-signed document includes verifying a digital signature related to the document, validating at least one certificate associated with the signature, and storing audit information into a data structure movable as a unit. The audit information relates to verifying the digital signature and validating the at least one certificate, thereby retaining evidence that the document was verified. The method also includes thereafter displaying the audit information.

In some embodiments, storing audit information includes storing the audit information on a client computing device. Storing audit information may include storing the audit information on a server computing device. The method may include archiving the audit information to an archive server.

In still other embodiments, a user-viewable combined verification report relating to a digitally-signed document includes verification information relating to at least one digital signature of the document verification thereof and validation information relating to at least one digital certificate relating to the at least one digital signature. The combined verification report may include a trusted timestamp that indicates a verification date and verification time for the at least one digital signature. The combined verification report may include a trusted timestamp that indicates a validation date and time for the at least one digital certificate relating to the at least one digital signature. The combined verification report may include an encoded representation of a verified signature, a hash of the document, a transaction ID, a name of the document, document metadata, and/or the like. The encoded representation of a verified signature may include an encoded representation of a verified signature using Base-64 encoding. The hash of the document may include a hash of the document using Base-64 encoding. The combined verification report also may include, for a specific signer, the signer's name, the time a signer signed the document, an indication of an algorithm used to sign the document, a signer certificate, and/or the like. The combined verification report may include, for a specific certificate, an OCSP response relating to the validity of the certificate, an SCVP response relating to the validity of the certificate, a certificate status code, a certificate status message, a CRL used to validate the certificate, and/or the like.

### BRIEF DESCRIPTION OF THE DRAWINGS

A further understanding of the nature and advantages of the present invention may be realized by reference to the remaining portions of the specification and the drawings wherein like reference numerals are used throughout the several drawings to refer to similar components. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 illustrates a client-side verification generator according to embodiments of the present invention.

FIG. 2 illustrates a server-side verification generator according to embodiments of the present invention.

FIG. 3 illustrates a combined verification report (CVR) according to embodiments of the invention.

FIG. 4 illustrates a verification and validation process according to embodiments of the invention.

FIG. 5 includes a screen shot of a user interface useful for viewing document verification results.

### DETAILED DESCRIPTION OF THE INVENTION

It is desirable for encryption products to store signature verification and certificate validation results for a given document in a common data structure, possibly along with the document and digital signature. Such records would include a timestamp for each time the signatures are verified, the certificates are validated, and/or the document is accessed. It is also desirable for audit information to be stored locally so that a user would not have to access a server to view the information. It is also desirable to have a user interface that displays the audit information in an understandable format, even for complex documents having many signatures and certificates. Thus, systems and methods are needed that address these and other needs.

Embodiments of the present invention provide systems and methods for creating, storing, archiving, and viewing audit information relating to verification and validation of digitally-signed documents. Embodiments may also include combined verification reports that document the audit results. Embodiments may be implemented locally, for example on a user computer, or remotely, for example on a server computer. Here, “document,” when used as a noun, refers to text, code, a message, other sequence of bits, or the like, conveyed from a sender to a user.

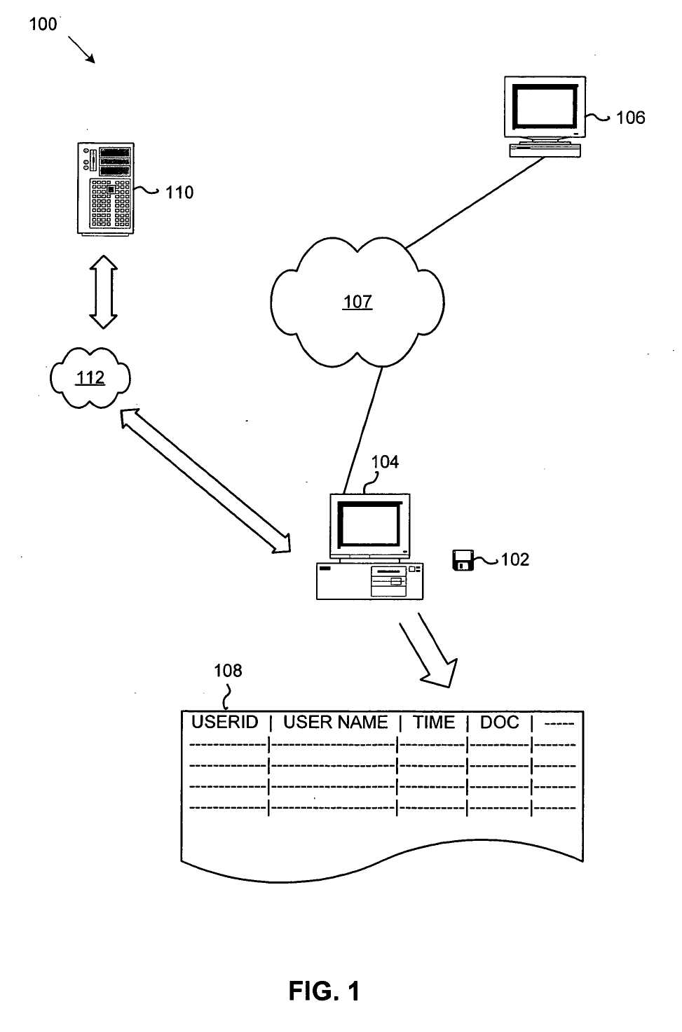

Having described embodiments of the invention generally, attention is directed to FIG. 1, which illustrates an exemplary “client-side” embodiment 100 of the invention. In this embodiment, the verification and validation process is accomplished by an application 102 residing on a user computing device 104 that us also used to provide documents to users. The application 102 may be any computer-executable instruction set for accomplishing the functions described herein. In some embodiments, the application comprises a software module, such as a plug-in, programmed to work with a primary application, such as a web browser or a word processor. In other embodiments, the application comprises a feature embedded into a primary application. In still other embodiments, the application comprises a standalone application. In some embodiments, the application works only on a limited number of file types. In still other embodiments, the application works on a wide variety of file types. Many other examples are possible. The user computing device 104 may comprise any of a number of well known devices, such as a laptop, a workstation, a PC, a desktop, a PDA, or the like.

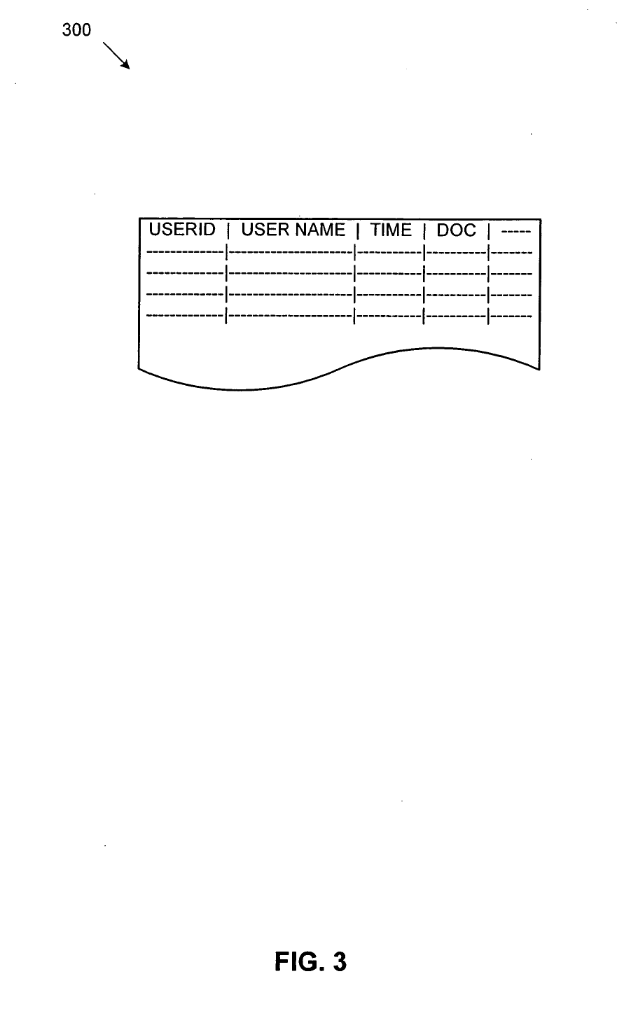

Once an intended recipient receives an encrypted document from a sender 106, usually by way of a network 107, the application 102 verifies the signatures and validates the associated certificates. The application also produces a combined verification report (CVR) 108 that documents the process. The CVR 108 may include a number of entries as will be described in greater detail hereinafter with respect to FIG. 3.

In this embodiment, the CVR 108 may be stored locally on the user computing device 104 in any of a number of well know data structures. For example, the CVR may comprise a record in a database, a text file, a formatted document file, a spreadsheet file, or the like. In a specific embodiment, the CVR is stored in XML format, one example of which is illustrated in Appendix A. In some embodiments, the CVR is stored as part of the document to which it pertains.

The CVR can be archived to an archive server 110. In some embodiments, this comprises copying the CVR, usually via a network 112, to the archive server using a secure transmission protocol such as SSL. The network 112 may be a part of the network 107, such as the Internet, or may be, for example, an internal network, such as an intranet. At the archive server 110, the CVR may be stored as a a record in a database, a text file, a formatted document file, a spreadsheet file, or the like. The CVR is stored in XML format in a specific embodiment.

Those skilled in the art will appreciate that client-side embodiment 100 is merely exemplary. Many other examples of client-side embodiments are possible and apparent to those skilled in the art in light of this disclosure.

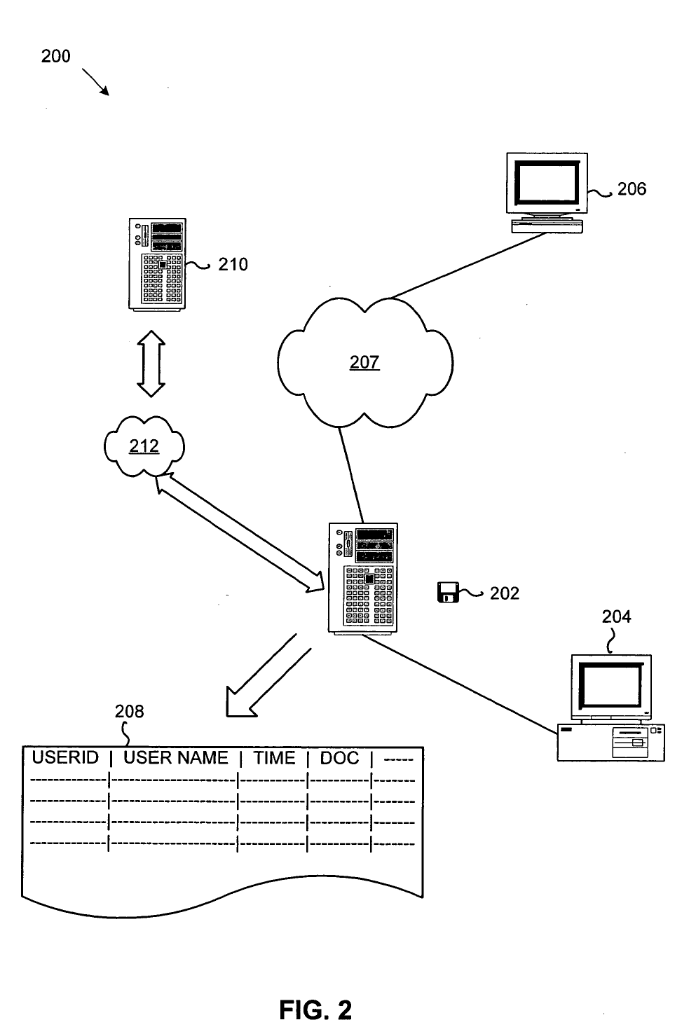

Attention is directed to FIG. 2, which illustrates an exemplary “server-side” embodiment 200 of the invention. As with the embodiment 100 of FIG. 1, this embodiment is merely exemplary of a number of possible server-side embodiments. In the embodiment shown, a verification and validation application 202 resides on a server computer 203 through which a user computer 204 accesses external resources, such as a sender 206 via a network 207. The user computer 204 may be any of the aforementioned computing devices. The server computer 203 may be any suitable computing device. As with the previous embodiment, the application 202 may be a standalone application, a module, an embedded feature, or the like.

The application 202 may be executed by a user using a client computer or may be configured to execute automatically upon receipt of a document from a sender. The application 202 creates a CVR 208 and stores it locally in one or more of the aforementioned formats. As with the previous embodiment, the CVR may be archived to an archive server 210 via a network 212.

Having described two exemplary embodiments, attention is directed to FIG. 3, which illustrates an embodiment of a CVR 300 according to the invention. A sample CVP in XML format is provided as Appendix A hereto. The CVR 300 shown includes information relating to the verification and validation of particular digitally-signed documents. In some embodiments, the CVR is updated each time the document to which it pertains is accessed, which may include merely opening the document, verifying and validating the digital signatures and associated certificates, and/or the like. In other embodiments, a new CVR is created each time a document is accessed.

As previously mentioned, the CVR may be stored at a client computer and/or a server computer. Further, the CVR may be loaded to an archive server. The CVR may be stored as a standalone file, a record in a database, an entry in a spreadsheet, and/or the like. The CVR may be stored in any of a number of well-known formats. In a specific embodiment, the CVR is stored in XML format. In other embodiments, the CVR may be an Acrobat® format file, a HTML file, an ASCII text file, a scanned digital image, a word processing document, or the like. In some embodiments, the CVR is stored as part of the document to which it relates. Many other examples are possible.

The CVR may include any or all of a number of entries. For example, the CVR may include a USERID that identifies the recipient of the document or someone who accesses the document, the user's name, the time the document was verified, the verification result, and the like. If the CVR is stored in a database along with CVRs for other documents, then each CVR may include an identifier of the document to which it pertains.

In some embodiments, the CVR includes the verification and validation status of the document. For each signature in the document, the CVR may include the signature that was verified, a trusted timestamp for the signature, and any digital notarizations associated with the signature. The CVR may include an encoded representation of the signature that was verified, which may use, for example, Base-64 encoding. The CVR may include a hash of the document that was verified, which also may use Base-64 encoding. In some embodiments, the CVR includes a transaction ID, a unique identifier that can be used to located the CVR at a later time, if, for example, the CVR is stored on an archive server while the transaction ID is stored in the document. The CVR also may include the name of the document that was verified and/or metadata about the document (e.g., the title of the document, author of the document, document summary, etc.).

Signatures may include multiple signers. The CVR may include, for each signer, the signer's information, the signing time, an indication of the algorithm used to sign, the message digest algorithm, the signer certificate, and the signer certificate chain. For each certificate in the chain for each signer, the CVR may include an OCSP or SCVP response relating to the validity of the certificate, including the certificate status code, the certificate status message, and binary and/or textual representation of the OCSP or SCVP response. The CVR also may include a binary and/or textual representation of the OCSP or SCVP request. In some embodiments, the CVR includes information identifying a certificate revocation list used to validate the certificate or any other information that proves that the certificate's validity was checked. Those skilled in the art can derive other embodiments upon review of this disclosure.

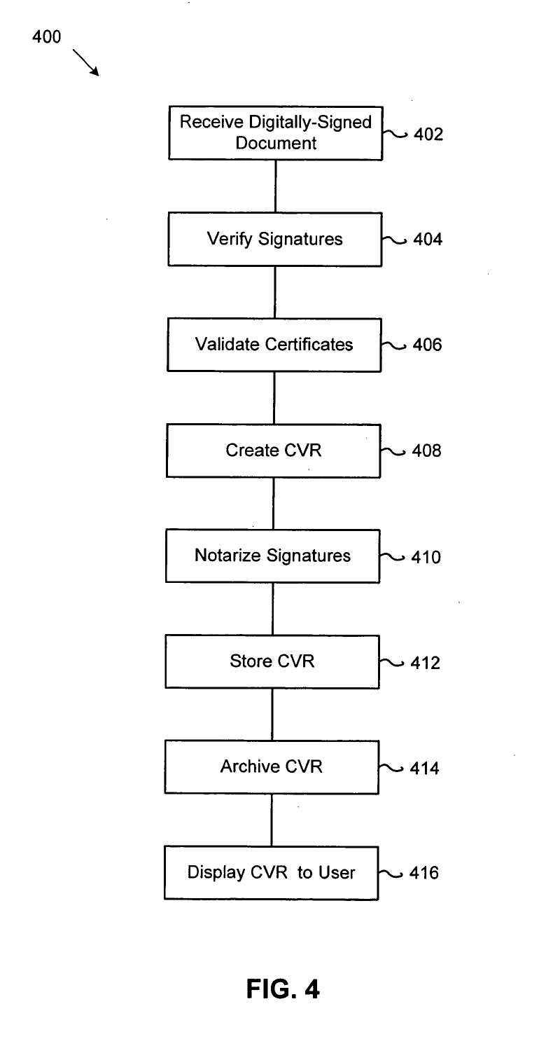

Attention is directed to FIG. 4, which illustrates an embodiment of a method 400 of verifying digitally-signed documents according to the invention. Method 400 may be implemented in either of the aforementioned embodiment or other appropriate system. Those skilled in the art will appreciate that Method 400 is merely exemplary of a number of possible embodiments. Other embodiments may include more, fewer, or different steps than those described herein. Further, the steps described herein need not be traversed in the order shown here.

Method 400 begins at block 402, when a digitally-signed document is received. In some embodiments, this event triggers subsequent verification of the document. In others, a user initiates the subsequent operations. The document may be in any of a variety of formats. For example, the document may be in Adobe Acrobat®, HTML, XML, ASCII, or other suitable format. The document may comprise, for example, a scanned digital image, a formatted text document, or the like. Examples of formatted text documents include Microsoft® Word documents including text and/or other document objects, such as images, boxes, data structures, and the like. Other examples include ANSI text, Unicode text, rich text format (RTF) documents, and the like.

At block 404, one or more digital signatures on the document are verified. As is known, this may comprise decrypting the document, decrypting the signature, hashing the document, and/or comparing the hash to the decrypted signature. In a specific embodiment, the digital signature is in PKCS#7 [PUBLIC KEY CRYPTOGRAPHY STANDARDS No. 7: CRYPTOGRAPHIC MESSAGE SYNTAX STANDARD (RSA Laboratories, Version 1.5, Nov. 1, 1993)].

At block 406, the digital certificates associated with each signature are validated. This may comprise validating each certificate in a certificate chain leading to a trusted root certificate. Validating certificates may comprise querying using OCSP (Online Certificate Status Protocol) or Simple Certificate Validation Protocol (SCVP) to obtain information relating to the validity of each certificate. In some embodiments, validating certificates comprises referencing a CRL (Certificate Revocation List). Other examples are possible and apparent to those skilled in the art.

At block 408, a CVR is created. The CVR includes the information described previously with respect to FIG. 3.

At block 410, a portion or all of the CVR may be notarized and the results stored as part of the CVR. In some embodiments, the CVR or a hash of the CVR are sent to a third party notary service which signs the CVR or CVR hash. A new CVR is then created which contains the original CVR along with the new signature created by the notary service. The signature from the notary service may optionally include a timestamp representing the time of the notarization.

At block 412, the CVR is stored. This may comprise storing the CVR on a user computer or a server computer. The CVR may be stored as a record in a database, an entry in a spreadsheet or other document, as a standalone file, or the like. The CVR may be stored as part of the document to which it relates. The CVR may be stored in any of a variety of formats, including, for example, XML.

At block 414, the CVR is archived to an archive server. This may comprise securely transmitting the CVR to the archive server using SSL or other appropriate file transfer protocol.

At block 416, the CVR is viewed by a user handling the verified document. The CVR may be viewed in any of a number of ways. A user may view the CVR on his computer monitor and/or may print the CVR. The user may access the CVR via a web browser, in some examples. Depending on the format of the CVR, the user may view it using an application, such as a word processor, spreadsheet program, or the like, or present it to another program for further processing. With respect to embodiments that store the CVR in XML format, an XML stylesheet may be used to render the CVR. Many other examples are apparent to those skilled in the art in light of this disclosure.

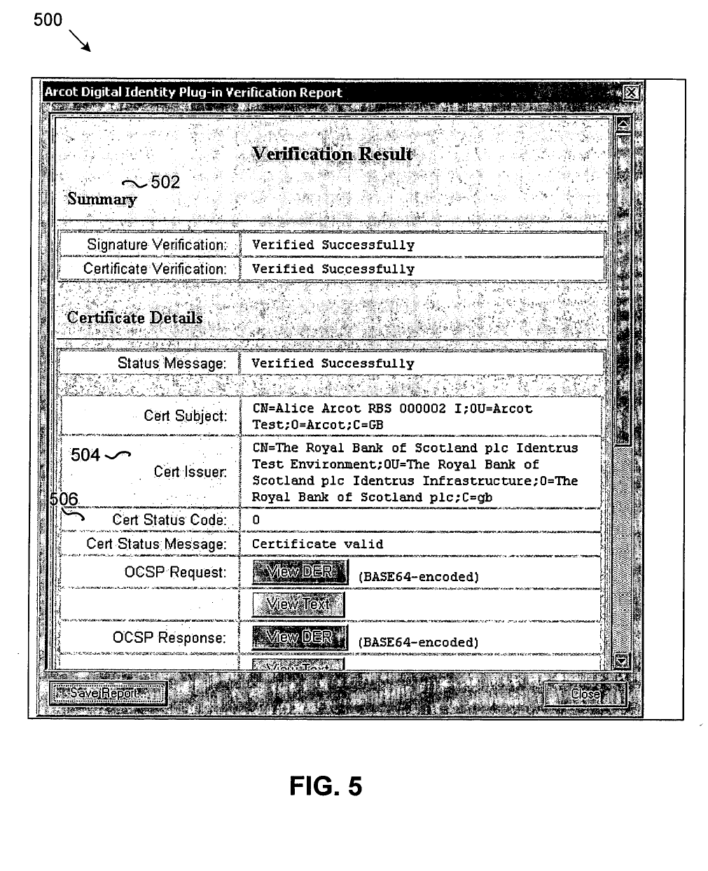

FIG. 5 includes a screen shot of a user interface 500 according to embodiments of the invention. Using the user interface 500, a user may view information relating to the validation status of a signature and/or the validation status of any associated certificates. The user interface 500 may be displayed on a device such as the user computing device 104 of FIG. 1.

The user interface 500 may include, for example, summary information 502, such as whether a signature has been verified successfully and whether a certificate has been verified successfully. Additional details may be included relating to the certificate, such as the certificate issuer 504 and/or whether the certificate remains valid 506. Other embodiments may include additional information.

Having described several embodiments, it will be recognized by those of skill in the art that various modifications, alternative constructions, and equivalents may be used without departing from the spirit of the invention. Additionally, a number of well known processes and elements have not been described in order to avoid unnecessarily obscuring the present invention. For example, those skilled in the art know how to arrange computing devices into a network and configure communication among them. Accordingly, the above description should not be taken as limiting the scope of the invention, which is defined in the following claims.

1. A computer-readable medium having stored thereon computer-executable instructions for implementing a method of verifying a digitally-signed document, comprising:
stored instruction for verifying a digital signature related to the document;
stored instruction for validating at least one certificate associated with the signature;
stored instruction for storing audit information into a data structure movable as a unit, the audit information relating to verifying the digital signature and validating the at least one certificate, thereby retaining evidence that the document was verified; and
stored instruction for thereafter displaying the audit information.

2. The computer-readable medium of claim 1, wherein the stored instruction for storing audit information comprises stored instruction for storing the audit information on a client computing device.

3. The computer-readable medium of claim 1, wherein the stored instruction for storing audit information comprises stored instruction for storing the audit information on a server computing device.

4. The computer-readable medium of claim 1, further comprising stored instruction for archiving the audit information to an archive server.

5. The computer-readable medium of claim 1, wherein the stored instruction for storing audit information comprises stored instructions for storing the audit information in XML format.

6. The computer-readable medium of claim 1, wherein the stored instruction for storing audit information comprises stored instruction for creating a combined verification report.

7. The computer-readable medium of claim 6, wherein the combined verification report includes at least one selection from the group consisting of:
a trusted timestamp that designates a date and time when verifying was performed;
digital notarizations associated with at least one signature of the document;
an encoded representation of a verified signature;
a hash of the document;
a transaction ID;
a name of the document; and
document metadata.

8. The computer-readable medium of claim 7, wherein the encoded representation of a verified signature comprises an encoded representation of a verified signature using Base-64 encoding.

9. The computer-readable medium of claim 7, wherein the hash of the document comprises a hash of the document using Base-64 encoding.

10. The computer-readable medium of claim 1, wherein the stored instruction for storing audit information comprises stored instruction for embedding the audit information in the document.

11. The computer-readable medium of claim 1, wherein the stored instruction for storing audit information comprises stored instruction for storing the information in a common directory with the document.

12. The computer-readable medium of claim 1, wherein the stored instruction for storing audit information comprises stored instruction for linking the information to the document using a unique identifier.

13. The computer-readable medium of claim 1, wherein the document is in a format selected from the group consisting of Adobe Acrobat®, HTML file, XML file, ASCII text file, scanned digital image, and Microsoft® Word document.

14. The computer-readable medium of claim 1, wherein the digital signature is in PKCS#7 format.

15. The computer-readable medium of claim 1, further comprising stored instruction for digitally notarizing the audit information.

16. The computer-readable medium of claim 1, wherein the computer-executable instructions comprise a selection from the group consisting of standalone application, software module, plug-in, and application feature.

17. A method of verifying a digitally-signed document, comprising:
verifying a digital signature related to the document;
validating at least one certificate associated with the signature;
storing audit information into a data structure movable as a unit, the audit information relating to verifying the digital signature and validating the at least one certificate, thereby retaining evidence that the document was verified; and
thereafter displaying the audit information.

18. The method of claim 17, wherein storing audit information comprises storing the audit information on a client computing device.

19. The method of claim 17, wherein storing audit information comprises storing the audit information on a server computing device.

20. The method of claim 17, further comprising archiving the audit information to an archive server.

21. The method of claim 17, wherein storing audit information comprises storing the audit information in XML format.

22. The method of claim 17, wherein storing audit information comprises creating a combined verification report.

23. The method of claim 22, wherein the combined verification report includes at least one selection from the group consisting of:
a trusted timestamp that designates a date and time when verifying was performed;
digital notarizations associated with at least one signature of the document;
an encoded representation of a verified signature;
a hash of the document;
a transaction ID;
a name of the document; and
document metadata.

24. The method of claim 23, wherein the encoded representation of a verified signature comprises an encoded representation of a verified signature using Base-64 encoding.

25. The method of claim 23, wherein the hash of the document comprises a hash of the document using Base-64 encoding.

26. The method of claim 17, wherein storing audit information comprises embedding the audit information in the document.

27. The method of claim 17, wherein storing audit information comprises storing the information in a common directory with the document.

28. The method of claim 17, wherein storing audit information comprises linking the information to the document using a unique identifier.

29. The method of claim 17, further comprising digitally notarizing the audit information.

30. A user-viewable combined verification report relating to a digitally-signed document, comprising:
verification information relating to at least one digital signature of the document verification thereof; and
validation information relating to at least one digital certificate relating to the at least one digital signature.

31. The combined verification report of claim 30, further comprising:
a trusted timestamp that indicates a verification date and verification time for the at least one digital signature.

32. The combined verification report of claim 30, further comprising:
a trusted timestamp that indicates a validation date and time for the at least one digital certificate relating to the at least one digital signature.

33. The combined verification report of claim 30, further comprising a selection from the group consisting of:
an encoded representation of a verified signature;
a hash of the document;
a transaction ID;
a name of the document; and
document metadata.

34. The combined verification report of claim 33, wherein the encoded representation of a verified signature comprises an encoded representation of a verified signature using Base-64 encoding.

35. The combined verification report of claim 33, wherein the hash of the document comprises a hash of the document using Base-64 encoding.

36. The combined verification report of claim 30, further comprising a selection, for a specific signer, from the group consisting of:
the signer's name;
the time a signer signed the document;
an indication of an algorithm used to sign the document; and
a signer certificate.

37. The combined verification report of claim 30, further comprising a selection, for a specific certificate, from the group consisting of:
an OCSP response relating to the validity of the certificate;
an SCVP response relating to the validity of the certificate;
a certificate status code;
a certificate status message; and
a CRL used to validate the certificate.
